(19) United States
(12) Patent Application Publication
(10) Pub. No.: US 2023/0274598 A1
(43) Pub. Date: Aug. 31, 2023

(54) HOLDING DEVICE AND ARTICLE SUPPLY APPARATUS

(71) Applicant: BANDAI CO., LTD., Tokyo (JP)

(72) Inventors: Hajime KONDO, Tokyo (JP); Tatsushi IKARASHI, Tokyo (JP); Nobuo KUROKAWA, Tokyo (JP); Shoji YAMAZAKI, Batangas (PH); Shinsuke SUGA, Batangas (PH); Tomoaki MIMURA, Batangas (PH)

(21) Appl. No.: 18/173,602

(22) Filed: Feb. 23, 2023

(30) Foreign Application Priority Data
Feb. 25, 2022 (JP) 2022-028334

(51) Int. Cl. G07D 3/12; G07D 3/16

(52) U.S. Cl. CPC G07D 3/125; G07D 3/16

(57) ABSTRACT

A coin holding device includes a mechanism for treating coins fed in a plurality of feeding ports thereby supplying an article. The coin holding device capable of holding the fed coins, comprises a first opening in which some coins are fed, a second opening in which other coins are fed, a first path part through which coins fed in the first opening pass, a second path part through which coins fed in the second opening pass, a first holding unit capable of holding coins which pass through the first path part and a second holding unit capable of holding coins which pass through the path part, wherein the first path part and the second path port are arranged so as to face each other.

### CROSS-REFERENCE TO RELATED APPLICATIONS

The disclosure of Japanese Patent Application No. 2022-028334 filed on Feb. 25, 2022 including specification, drawings and claims is incorporated herein by reference in its entirety.

### TECHNICAL FIELD

Described herein are a holding device and an article supply apparatus.

### BACKGROUND ART

There is an article supply apparatus from which an article is supplied in accordance with payment of consideration. Japanese Patent Application Publication No. 2008-27226 teaches such an article supply apparatus capable of supplying an article based on the payment of consideration made by feeding a coin.

### SUMMARY

### Technical Problem to be Solved

In such an article supply apparatus, there is a demand for a mechanism capable of supplying an article by treating coins fed in a plurality of feeding ports.

Proposed herein is a coin holding device and an article supply apparatus having the coin holding device, which has such a mechanism for treating coins fed in a plurality of feeding ports thereby supplying an article.

As an embodiment, a holding device capable of holding fed coins, comprises a first opening in which a first group (or kind) of the coins are fed, a second opening in which a second group (or kind) of the coins are fed, a first path part through which the first group (or kind) of the coins fed in the first opening, is capable of passing, a second path part through which the second group (or kind) of the coins fed in the second opening is capable of passing, a first holding unit capable of holding the first group (or kind) of the coins which pass through the first passage, a second holding unit capable of holding the second group (or kind) of the coins which pass through the second passage, wherein the first passage and the second passage face each other, and a first holding unit and a second holding unit face each other.

As another embodiment, an article supply apparatus capable of supplying an article comprises a holding device, an accommodation unit which accommodates articles, and an operation unit, which is operated in order to supply an article accommodated in the accommodation unit, wherein the first holding unit and the second holding unit are capable of being moved in a direction in which a lower side of the first holding unit and that of the second holding unit are separated from each other, in accordance with an operation performed to the operation unit.

According to the above configuration, it is possible to propose a coin holding device and an article supply apparatus, having a mechanism for supplying an article by treating a plurality of coins fed in two or more feeding ports.

Thus, there are a number of advantages and there is no requirement that a claim be limited to encompass all of the advantages. In addition, the foregoing has outlined rather broadly the features and technical advantages in order that the detailed description of the invention that follows may be better understood. Additional features and advantages will be described hereinafter which form the subject of the claims.

### BRIEF DESCRIPTION OF DRAWINGS

For a more complete understanding, and the advantages thereof, reference is now made to the following description taken in conjunction with the accompanying drawings, in which:

FIG. 1 is a diagram showing an example of an exterior appearance of an article supply apparatus 100 according to an embodiment of the present invention;

FIG. 2 is a block diagram showing an example of a hardware configuration of a holding device 102 according to an embodiment of the present invention;

FIG. 3A is a side view of an example of the structure of the holding mechanism 300 according to an embodiment of the present invention;

FIG. 3B is another side view thereof on the opposite side of the holding mechanism 300;

FIGS. 4A through 4C illustrate an example of a configuration of a holding unit according to an embodiment of the present invention;

FIGS. 5A through 5C are diagrams showing an example of an exterior structure of a holding unit according to an embodiment of the present invention;

FIGS. 6A through 6C are diagrams showing an example of an exterior structure of a discrimination unit 310 in the holding mechanism according to an embodiment of the present invention;

FIG. 7 is a diagram showing an example of a configuration of a mounting unit 311 of the discrimination unit 310 in the holding mechanism 300 according to an embodiment of the present invention;

FIGS. 8A and 8B are diagrams showing an example of an exterior structure of a discrimination unit 310 according to an embodiment of the present invention;

FIGS. 9A, 9B, 9C and 9D are diagrams showing an example of an interior structure of a discrimination unit 310 according to an embodiment of the present invention; and

FIG. 10 illustrates a transmission mechanism for transmitting a power according to an operation applied to a handle 103 according to an embodiment of the present invention.

### DETAILED DESCRIPTION

A description of embodiments will now be given below, referring to drawings. While the claims are not limited to such embodiments, an appreciation of various aspects of the invention is best gained through a discussion of various examples thereof. Further, combinations of elements or features described below are not necessarily indispensable. Two or more elements or features described below may be arbitrarily combined. The same symbols or signs are assigned to the same elements or similar elements and duplicate explanation thereof will be omitted.

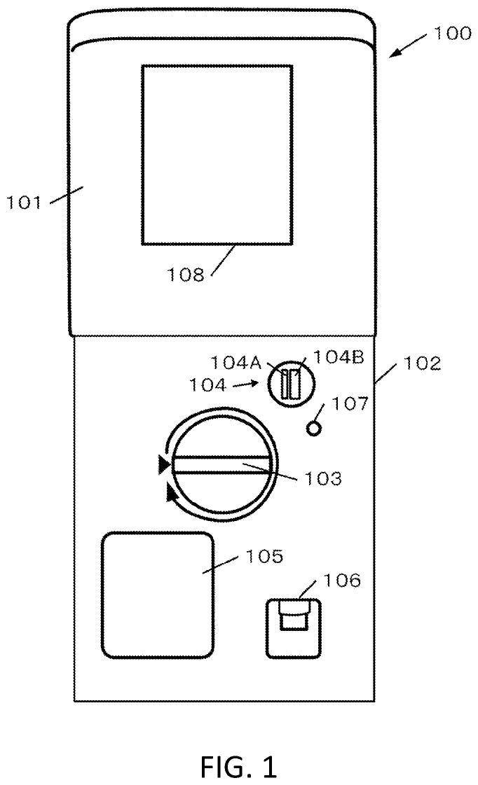

Next, an exterior appearance of the structure of an article supply apparatus 100 will be described, referring to FIG. 1. FIG. 1 shows an example of a front exterior appearance of the article supply apparatus 100 according to the present embodiment. In FIG. 1, a main body of the article supply apparatus 100 comprises a front wall, a rear wall, and side walls, and an article accommodation unit 101 is a container (or a bucket, a case etc.) in which articles to be supplied from the article supply apparatus 100 are accommodated. The article accommodation unit 101 may be made of transparent plastic, so that the articles accommodated inside the article accommodation unit 101 can be visually recognized. The articles accommodated in the accommodation unit 101 may be capsules in each of which a toy, an electronic device, a doll or the like is enclosed. The articles may be accommodated in the accommodation unit 101 in a state where each article is not enclosed in a capsule.

The article accommodation unit 101 is disposed on an upper side of the holding device 102. An article transportation mechanism which takes out an article from the article accommodation unit 101, and which transports it to a take-out port 105 in order to supply the article, is disposed in the holding device 102. A handle 103, a feeding port unit 104, the take-out port 105, a return port 106, a return button 107 are arranged on a front face of the holding device 102. A display 108, which is, for example, a liquid crystal panel etc. may be arranged on at least one of the article accommodation unit 101 and the holding device 102.

The handle 103 is an operation member which is rotatable in arrow directions when a consideration is paid. An article is supplied to the take-out port 105 when a user rotates the handle 103. The rotation of the handle 103 is suppressed by a lock mechanism, for example, in a state where a payment of consideration such as a predetermined number of coins is not confirmed. When the payment of the consideration is confirmed, the lock mechanism is released so that the handle 103 become rotatable.

The coin feeding port unit 104 is used for feeding coins in order to pay the consideration with the coins. The feeding port unit 104 may have two or more kinds of feeding ports, depending on the sizes of the coins or the number thereof. The coins are formed as approximately disc-shaped articles having a predetermined thickness. The coins may be changes (currency), coins which are substitutes thereof having cash value, tokens, medals and so on. The feeding port unit 104 includes a first feeding port 104A and a second feeding port 104B. The number of coins to be fed in the first feeding port 104A and those in the second feeding port 104B are respectively predetermined. In this embodiment, when the total number of coins fed in these feeding ports reaches a predetermined number, the handle 103 becomes rotatable.

In case where two or more coins are fed in the first and second feeding ports, the width or length of the opening of one of the feeding ports, which is set so as to receive more coins than that of the other feeding port, may be longer than that of the other feeding port. In such a configuration where the number of coins to be fed in one of the feeding ports is set so as to be deferent from that the other feeding port, it is possible for a user to visually recognize the feeding port which is set to receive more coins. In FIG. 1, the width of the second feeding port 104B is larger than that of the first feeding port 104A, so as to indicate that more coins should be fed in the second feeding port 104B. As stated above, the length of one of the feeding ports may be set larger than that of the other feeding ports, instead of setting the width of the one of the feeding ports larger.

In addition, the feeding port unit 104 may be switched between a state where coins can be received and a state where no coins can be received, by controlling an inner mechanism. When coins equivalent to a predetermined consideration have been received or when it is not time or a turn to feed coins, a shutter of the feeding ports may be closed so that no coin can be fed therein. Specifically, when the first feeding port 104A accepts coins, the shutter of the second feeding port 104B is closed so that no coin is fed in the second feeding port 104B. Further, after a predetermined number of coins are fed in the first feeding port 104A, the second feeding port 104A is closed, and the shutter of the second feeding port 104B is opened so that coins can be fed therein. And then, when the rest of coins is fed in the second feeding port 104B, the shutter of the second feeding port 104B is closed so that excessive coins may not be fed therein.

The feeding port unit 104 includes a depression portion having a curved face. The feeding ports 104A and 104B are formed near the bottom of the depression (the deepest part). By this configuration, even a small child may easily feed a coin in the feeding port 104 by sliding a coin and tracing the curved face.

The take-out port 105 is used to take out an article supplied by rotating the handle 103. The take-out part 105 is covered by a transparent or translucent lid (or cover) and a user takes out the article from the take-out port 105 by opening the lid. The return port 106 is configured so as to return the fed coins according to an operation performed to the return button 107 so that the user can take out the returned coins from the device. Here, when the number of coins equivalent to the price of an article have been fed, it may be configured that an operation performed to the return button 107 is not accepted. On the other hand, it may be configured to accept an operation performed to the return button 107 where the number of coins equivalent to only part of the price of the article have been fed. In such case when the operation is accepted, all the fed coins may be returned to the user. In addition, when the number of coins in excess of the price of the article are fed, the operation performed to the return button 107 may be accepted. In such case, when the operation is accepted, part or all of the fed coins may be returned. At this time, part of the fed coins to be returned may be treated as surplus

In addition, when, as a result of coin discrimination, it is determined that proper or authentic coins are not fed, the coins discriminated as improper or not authentic are returned from the return port 106. For example, when hard cash other than specific coins is fed in the feeding port(s) although the specific coins should be used, the fed hard cash is returned as improper or not authentic. When counterfeit money (coin etc.) is fed, it is returned as an improper coin is fed.

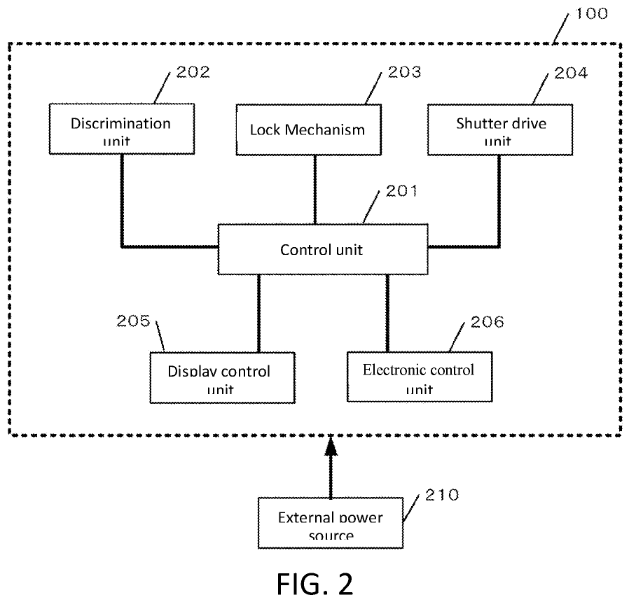

Next, a hardware configuration of at least part of the holding device 102 disposed in the article supply apparatus 100 according to the embodiment will be explained below as an example, referring to FIG. 2. In FIG. 2, a control unit 201 is arranged in the holding device 102, and each of units described below is connected to the control unit 201. The control unit 201 controls an operation of each unit, and specifically, the control unit 201 controls operations of these units and/or other units based on data (or information) provided from these units or processing results provided from these units. In addition, electric power for these operations is supplied to the holding device 102 from an external power source 210.

The discrimination unit 202 discriminates or judges coins suppled to the holding device 102, and the discriminated coins are discharged through paths, which are provided inside the article supply device 100, and which respectively correspond to the coin feeding ports 104A and 104B. In addition, when the discrimination unit 202 detects a coin(s), the discrimination unit 202 sends a detection notification to the control unit 201. Or when the discriminated coins are proper or genuine, the discrimination unit 202 may send the detection notification to the control unit 201. When a counterfeit or improper coin(s) is detected as a result of an authentication or discrimination detection performed by the discrimination unit 202, the detected coin is directly returned to the return port 106. When the discrimination unit 202 performs the authentication or discrimination detection, the detection result is sent to the control unit 201.

When the control unit 201 acquires the detection notification from the discrimination unit 202, the control unit 201 counts the number of times at which the detection notification is received, or the number of times at which authenticity is detected in the authenticity discrimination, thereby counting the number of the fed coins. If the discrimination unit 202 is detached from the holding device 102, since the control unit 201 cannot acquire the detection notification, the control unit 201 cannot count the number of the fed coins. The control unit 201 releases the lock of the lock mechanism 203 when the number of coins, which is counted based on the number of the received detection notifications, reaches a predetermined number. The handle 103 is rotated after the lock of the lock mechanism is released, and the control unit 201 resets the number of counted coins to zero.

In addition, although, in the present embodiment, the case where only one kind of coins are used is exemplified, cases where two or more types of coins are used may be within the scope of the present embodiment. In such cases, for example, a first type (group) of coins may be fed in the first feeding port 104A and the second type (group) of coins may be fed in the second feeding port 104B.

The lock mechanism 203 is a mechanism for suppressing (locking) rotation of the handle 103, and has two states i.e. a handle locking state and a handle unlocking state. The lock mechanism 203 operates so as to lock the rotation of the handle 103 in a normal state. When it is detected that the predetermined number of the coins, which are of a predetermined kind, are fed, the lock is released so that the handle 103 can be rotated.

A shutter drive unit 204 is disposed for each of the first feeding port 104A and the second feeding port 104B wherein closing and opening of the shatter for each feeding port is controlled in response to a command from the control unit 201. Specifically, at a time when a coin starts being fed, the control unit 201 performs a control to open the shutter for the first feeding port 104A, and to close the shutter for the second feeding port 104B. When the number of the coins fed in the first feeding port 104A reaches a first predetermined number, for example, four (4), the control unit 201 closes the shutter for the first feeding port 104A and opens the shutter for the second feeding port 104B. After that, when the number of the coins fed in the second feeding port 104B reaches a second predetermined number, for example, five (5), the control unit 201 controls the shutter drive unit 204 to close the second feeding port 104B so that no more coin is fed therein. In the above example, when nine (9) coins in total are fed, the lock of the handle 103 is released. However, the total number of coins to be fed is not limited to nine.

A display control unit 205 performs a display control to display predetermined information on the display 108 according to the control performed by the control unit 201. For the user, the display control unit 205 displays, on the display 108, a notification to the effect that, as a condition for rotating the handle 103, it is necessary to feed the second predetermined number of coins in the second feeding port 104B after the first predetermined number of coins are fed in the first feeding port 104A. And then, the display control unit 205 displays, on the display 108, a guidance to the effect that the user need to start feeding coins in one of the two feeding ports, that is, the first feeding port 104A. When a coin is fed in the first feeding port 104A, the display control unit 205 display, on the display 108, a count value of the number of the fed coins, which is notified by the control unit 201. When the display control unit 205 receives, from the control unit 201, a notification to the effect that the first predetermined number of coins are fed in the first feeding port 104A, the display control unit 205 displays, on the display 108, a guidance to the effect that the user need to put coins in the second feeding port 104B. After that, when the display control unit 205 receives, from the control unit 201, a notification to the effect that the second predetermined number of coins have been fed in the second feeding port 104B, the display control unit 205 displays, on the display 108, a notification to the effect that the handle 103 becomes rotatable. When the user rotates the handle 103, the display control unit 205 displays, on the display 108, a notification to the effect that the user is prompted to take out an article from the take-out port 105.

Although consideration is paid by using coins in the above description, the embodiment is not limited thereto. That is, the consideration may be paid by cashless payment (electronic payment) such as electronic money etc., when the number of coins held in a first holding unit 303 and (or) a second holding unit 304 does not reach the predetermined number(s). In such a configuration, an identification information from which each article supply apparatus can be uniquely identified, is displayed on each article supply apparatus, and when the identification information is obtained from a user terminal, the electronic payment becomes possible, and the supply of an article is allowed (a rotation operation by the handle 103 becomes possible) on condition that a process of electronic payment is completed. An electronic payment unit 206 is a processing unit for carrying out the electronic payment, wherein when the electronic payment is completed, the electronic payment unit 206 notifies the control unit 201 of the completion of the electronic payment. In addition, only when the number of coins held in a first holding unit 303 and a second holding unit 304 does not reach the predetermined number, the electronic payment by the electronic payment unit may be allowed. if the number of coins held thereby reaches the predetermined number, the control unit 201 makes the electronic payment by the electronic payment unit 206 unavailable (or nullifies the electronic payment), and allows only payment with coins.

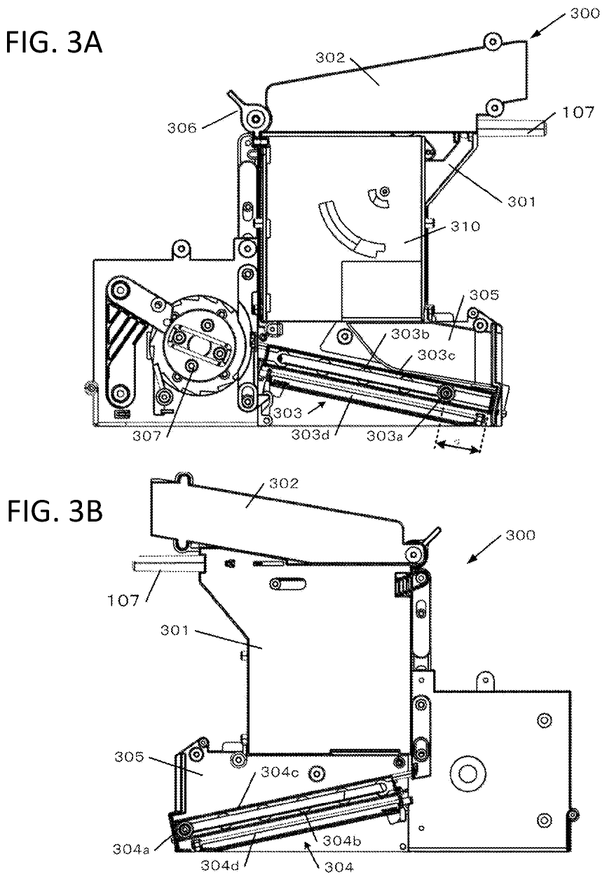

Next, a configuration of the inside of the holding device 102 for holding the fed coins according to the present embodiment will be explained below referring to FIGS. 3A and 3B. FIG. 3A is a side view of an example of the structure of the holding mechanism 300 in the inside of the holding device 102 according to an embodiment, wherein one of side faces (a first face) of the holding mechanism 300 is shown. FIG. 3B is another side view of the holding mechanism 300, wherein the other side face (a second face) of the holding mechanism 300 which is on the opposite side of the first face is shown. Specifically, the structure of the holding mechanism 300 will be described below referring to FIGS. 3A and 3B.

In FIGS. 3A and 3B, a unit corresponding to the control unit 201 shown in FIG. 2 is not included in the holding mechanism 300. Although the control unit 201 is disposed in the holding device 102 separately from the holding mechanism 300, the control unit 201 is connected to the discrimination unit 310 etc. of the holding mechanism, and controls operations of these units.

In FIGS. 3A and 3B, a first inclined portion 302 is arranged in the holding mechanism 300 so as to form a path section for transporting coins fed in the feeding port unit 104 (refer to FIG. 1) disposed on an upper side of a main body 301 for holding the discrimination unit 310. The first inclined portion 302 is arranged in the holding mechanism 300. The first inclined portion 302 comprises a first path part through which coins fed in the first feeding portion 104A (refer to FIG. 1) and a second path part through which coins fed in the second feeding port 104B (refer to FIG. 1). The first and second path parts 104A and 104B are passages having the size and length capable of transporting two or more kinds of coins or the same kind of coins, and each of them is inclined so as to go down from each feeding port 104 toward the discrimination 310. In addition, the main body portion 301 has a fixing lever 306 for fixing the discrimination unit 310 to the main body portion 301, wherein the discrimination unit 310 is detachable from the main body portion 301. Thus, the discrimination unit 310 is fixed to the main body 301 by using the fixing lever 306. In addition, the discrimination unit 310 can be detached from the main body portion 301 by operating the fixing lever 306.

The discrimination unit 310 shown in FIG. 3A corresponds to the discrimination unit 202 shown in FIG. 2. The discrimination unit 310 judges whether the fed coin is a predetermined kind of coin, and if it is the predetermined kind of coin, the discrimination unit 310 discharges the coin to the first holding unit 303 or the second holding unit 304 which is disposed on a lower side of the main body portion 301. In this embodiment, the length of the discrimination unit 310 in the longitudinal direction, is shorter than the shortest distance between a lower end of the first inclined portion 302 and an upper end of the first holding unit 303 or the second holding unit 304.

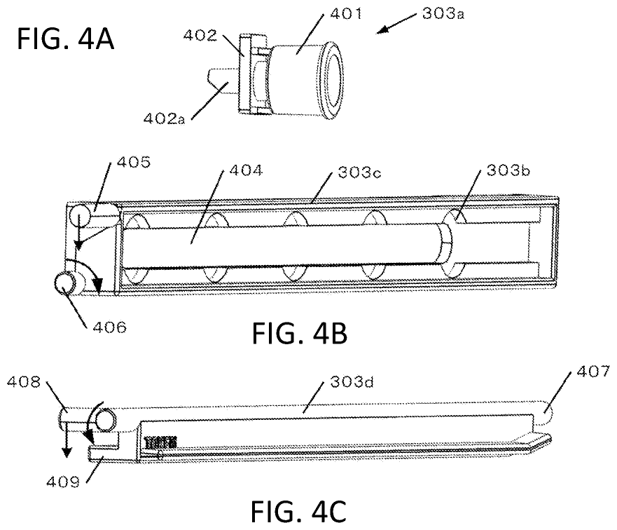

In this embodiment, the first holding unit 303 and the second holding unit 304 are arranged so as to face each other. The first holding unit 303 holds coins fed in the first feeding port 104A so that coins are not overlapped. The first holding unit 303 is inclined so that one end thereof is located on an upper side of the main body portion 301 (near the discrimination unit 310) and the other end thereof is located on a lower side of the holding device 102. By this configuration, the fed coins are held in order from the other end side of the first holding unit 303 without being overlapped. In addition, the first holding unit 303 includes a first track portion, which is inclined, so that coins can roll thereon due to the inclination. In addition, the first track portion has such a length that a predetermined number of coins can be held. The number of coins, which can be held in the first holding unit 303, may be set (changed) by moving the position of a first adjustment member 303a. The first holding unit 303 has a plurality of depressed portions 303b for setting the position of the first adjustment member 303a so that it is possible to set the number of coins held in the first holding unit 303 by arranging the first adjustment member 303a at any one of the depressed portions 303b. The first adjustment member 303a and the depressed portions 303b will be described later referring FIGS. 4A through 4C.

The holding unit 304 holds coins fed in the second feeding port 104B so that coins are not overlapped. The second holding unit 304 is disposed in the main body portion 301 so that one end of the holding unit 304 is located on an upper side of the main body portion 301 (near the discrimination unit 310) and the other end thereof is located on a lower side of the holding device 102. That is, the second holding unit 304 is inclined. By this configuration, the fed coins are held in order from the other end side of the first holding unit 303 without being overlapped. In addition, the second holding unit 304 includes a second track portion, which is inclined, so that coins can roll thereon due to the inclination. In addition, the second track portion has such a length that a predetermined number of coins can be held. The number of coins, which can be held in the second holding unit 304, can be set (changed) by moving the position of a second adjustment member 304a. The second holding unit 304 has a plurality of depressed portions 304b for setting the position of the second adjustment member 304a so that it is possible to set the number of coins held in the second holding unit 304 by arranging the second adjustment member 304a at any one of the depress 2sed portions 304b.

According to the present embodiment, a maximum number of coins which can be held in the second holding unit 304 is larger than a maximum number of coins which can be held in the first holding unit 303. As shown in FIG. 3A, the depressed portions, at one of which the first adjustment member 303a can be arranged, are formed in the first holding unit 303, wherein one of the depressed portions located nearest to the other end of the first holding unit 303 is formed so as to be spaced with a predetermined distance d from the other end of the first holding unit 303. On the other hand, as shown in FIG. 3B, the depressed portions, at one of which the second adjustment member 303b can be arranged, are formed in the second holding unit 304, wherein one of the depressed portions located nearest to the other end of the first holding unit 304 is formed in the vicinity of the other end of the second holding unit 304. That is, unlike the structure of the first holding unit 303, the depression portion formed nearest to the other end of the second holding unit 304 is arranged without such a distance d from the other end of the second holding unit 304. In addition, according to the present embodiment, the maximum number of coins which can be held in the first holding unit 303 and that in the second holding unit 304 are set to be different from each other. However, the maximum number of coins which can be held in the first holding unit 303 may be larger than that in the second holding unit 304, or they may be the same.

When the control unit 201 judges that the predetermined number of coins are fed, based on the number of times of the detection notifications about the fed coins which the control unit 201 receives, or the number of times of detections in which authenticity of a coin is determined in the authenticity discrimination, the control unit 201 releases the lock of a drive unit 307 connected to the handle 103 so as to be rotatable. When the drive unit 307 is rotated, the first holding unit 303 and the second holding unit 304 accordingly transit from a state where coins can be held therein to a state where coins are not held therein. The first holding unit 303 comprises an upper side member 303c and a lower side member 303d. Similarly, the second holding unit 304 comprises an upper side member 304c and a lower side member 304d.

The upper side members 303c and 304c respectively function as a first setting portion and a second setting portion which can respectively adjustably set the number of coins held in the first holding unit 303 and the second holding unit 304 by changing the positions thereof. When the first holding unit 303 and the second holding unit 304 transit to a state where coins are not held therein according to the rotation of the handle 103, a lower side portion of the lower side member 303d and a lower side portion of the lower side member 304d are opened so as to be separated from each other (the first holding unit 303 and the second holding unit 304 are rotated to form a “truncated chevron shape” of KATAKANA (square form of Japanese syllabary) thereby when the first and second holding members 303 and 304 are viewed from the righthand toward the lefthand in FIG. 3A. By this operation, the coins held in the first and second holding units 303 and 304 are discharged into a coin accommodation unit (not shown) which is disposed below the holding units. After each holding unit discharges coins and transits to the state where coins are not held, new coins can be held.

The coin accommodation unit is disposed on a lower side of the first holding unit 303 and the second holding unit 304, that is, below the holding mechanism 300. The coin accommodation unit accommodates coins, which were held in the first holding unit 303 and coins, which were held in the second holding unit 304, together. In addition, in case where the kind of coins held in the first holding unit 303 is different from those held in the second holding unit 304, a first accommodation unit for a first kind of coins held in the first holding unit 303 and a second accommodation unit for a second kind of coins held in the second holding unit 304 may be separately prepared. In such case, the first accommodation unit and the second accommodation unit may be integrally formed if each kind of coins can be accommodated separately from the other kind(s) of coins. Or the first accommodation unit and the second accommodation unit may be configured as separate bodies from each other.

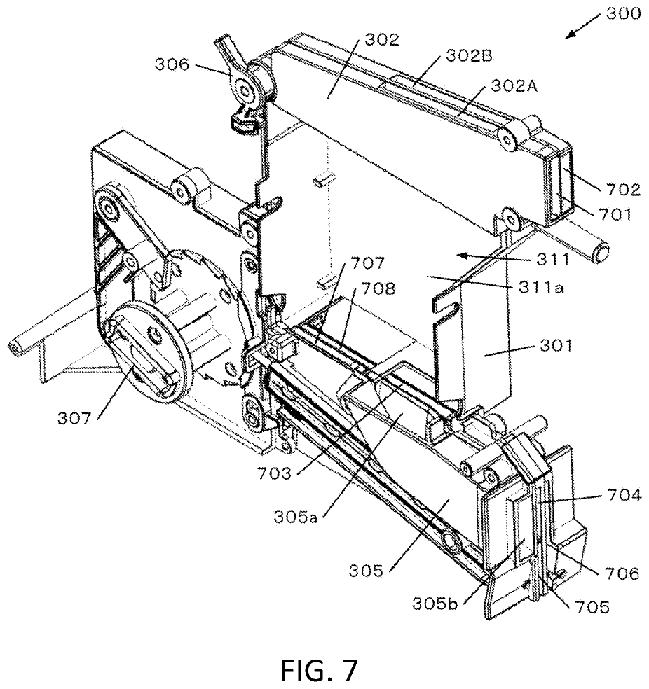

As described above, the first holding unit 303 and the second holding unit 304 have the first track portion and the second track portion respectively, in order to hold the discriminated coins. Each of the first track portion and the second track portion is inclined downward from a side of a coin discharge port of the discrimination unit 310 toward the other end portion of the holding unit (in a rightward direction in FIG. 3A or in a leftward direction in FIG. 3B). The direction of inclination of the first holding unit 303 and the second holding unit 304 is different from that of first inclined portion 302. That is, as shown in FIGS. 3A and 7, the first inclined portion 302 is inclined from the upper right side of FIG. 3A toward the lower right side thereof on a side where the discrimination unit 310 is located. On the other hand, as shown in FIGS. 3A and 3B, the first holding unit 303 and the second holding unit 304 are inclined downward from upper left on a side of the discrimination unit 310 in FIG. 3A (or upper right on FIG. 3B). The first adjustment member 303a, the second adjustment member 304a, and respective control members which are integrally formed therewith, are arranged around the other ends of the first holding unit 303 and the second holding unit 304 which are respectively located on a far lower side thereof from the discrimination unit 310 (lower righthand side in FIG. 3A or lower lefthand side in FIG. 3B). The control members integrally formed with the respective holding members function as stoppers so as to maintain coins held in the first holding unit 303 and the second holding unit 304. When an operation to the return button 107 is performed from the outside of the article supply apparatus 100 in a state where coins are held in each of the holding members, upper side end portions of the respective upper side members 303c and 304c are opened in a direction in which they are separated from each other, so that the first holding unit 303 and the second holding unit 304 form a reverse truncated chevron shape of KATAKANA (square form of Japanese syllabary) when the first holding unit 303 and the second holding unit 304 are viewed from the right hand side in FIG. 3A or the left hand side in FIG. 3B. By this movement, the control state of the control members, by which coins are held in each holding member, is released, so that the coins roll down toward the front side of the holding mechanism 300 along the inclination of the first track portion and the second track portion and are discharged from the return port 106.

When the discrimination unit 310 determines that the fed coin(s) is not the specified kind of coins, the fed coin is discharged to a discharge path 305 and so on without discharging the fed coin to the first holding unit 303 and the second holding unit 304. The discharge path 305 is connected to the return port 106, and the coins discharged to the discharge path 305 can be taken out from the return port 106. In addition, when an operation is performed to the return button 107, the coin holding state is released according to the operation of the return button 107, and the coins held in the first holding unit 303 and the second holding unit 304 are discharged to the return port 106.

FIGS. 4A, 4B and 4C are diagrams for illustrating the structure of the first holding unit 303. The figures show the first holding unit 303 which is taken apart into the first adjustment member 303a (FIG. 4A), the upper side member 303c (FIG. 4B) and the lower side member 303d (FIG. 4C). The first adjustment member 303a shown in FIG. 4A is integrally formed in a state where an insert member 402 is inserted inside a cylindrical member 401, and the feeding member 402 is energized toward the internal space of the cylindrical member 401 by a spring (not shown). This urging force acts in order to attach the first adjustment member 303a to the depressed portions 303b of the upper side member 303c. The cylindrical member 401 is arranged to protrude in an outside direction (a first direction: the near side in FIG. 4B) from a side face of the first holding member 303. The feeding member 402 has a projection portion 402a which protrudes in a direction opposite to the direction (a second direction: the back side on FIG. 4B) in which the cylindrical member 401 protrudes from the side face of the first holding member 303. The projection portion 402a functions as a control member (stopper) in order to stop coins from rolling down when the first holding unit 303 is in the holding state where the coins are held.

The upper side member 303c shown in FIG. 4B has a plurality of the depressed portions 303b (five depressed portions in the example shown in FIG. 4B), and a bottom portion of the cylindrical member 401 (a portion facing a side of the insert member 402 of the cylindrical member 401 shown in FIG. 4A) is fit in one of the depressed portions 303b. Each of the depressed portions 303b has an outer shape corresponding to the shape of the bottom portion of the cylindrical member 401. In addition, the upper side member 303c has an opening 404, and the first adjustment member 303a is attached to the upper side member 303c via the opening 404. The opening 404 is formed so as to pass through the five depressed portions 303b formed in the upper side member 303c so that the first adjustment member 303a may be moved to and fixed at an arbitrary one (position) of the five depressed portions 303b.

The upper side member 303c has a projection 405 and a rotation axis 406 on a side face thereof. When a force is applied to the projection 405 in a downward direction shown in a vertical arrow in accordance with an operation performed to the return button 107, an upper side of the upper side member 303c is moved so as to open in a clockwise direction (shown as a curved arrow) with respect to the rotation axis 406 as a center of rotation. Here, when the force applied by pressing the return button 107 is converted, through a power transmission mechanism (not shown), into a force which presses the projection 405 in the downward direction.

The lower side member 303d shown in FIG. 4C has an axis portion 407, a projection portion 408 which is connected to the axis portion 407 so that the axis portion 407 and the projection portion 408 may form a L-shape, and a bottom face portion 409 for holding coins in the first holding unit 303. The posture of the axis portion 407 of the lower side member 303d is maintained, by a mechanism (not shown) of the holding mechanism 300, in a posture allowing the bottom face portion 409 to support the coins thereon so as not fall down on a lower side. On the other hand, when the lock of the drive unit 307 is released on the condition that the predetermined number of coins are held thereon, and the handle 103 is rotated, a force is applied to the projection 408 in a lower side direction shown in an arrow by the power transmission mechanism (not shown) coupled to the drive unit 307. As such, the lower side member 303d is rotated with respect to the axis portion 407 as a rotation axis, in a direction shown in a curved arrow which is an counter clockwise direction, and the coin supporting state of the bottom face portion 409 is released so that the coins supported by the bottom face portion 409 fall down on the lower side.

In FIGS. 4A, 4B and 4C, the structure of the first holding unit 303 is shown. In the same manner, the second holding unit 304 may be configured. However, the second holding unit 304 is different from the first holding unit 303 in that the number of depressed portions 304b of the second holding unit 304 is six (6) although the number of the depressed portion 303b of the first holding unit 303 is five (5) in the above example. In addition, as another embodiment, the number of the depressed portions 303b may be greater than that of the depressed portions 304b.

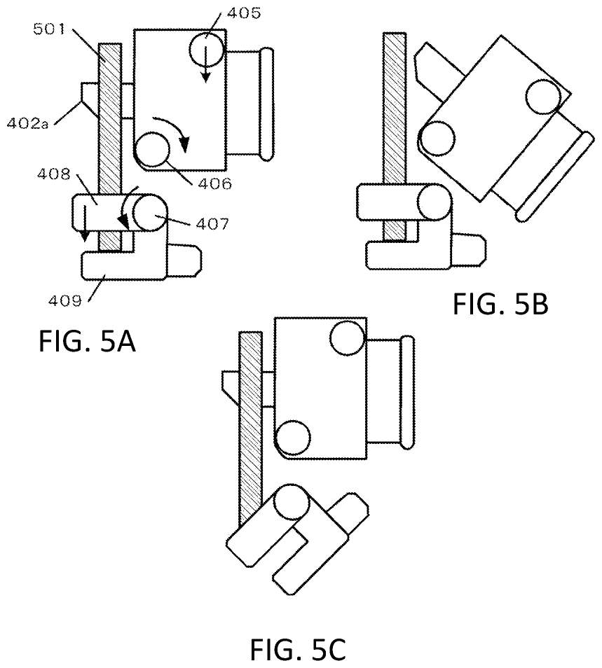

FIGS. 5A, 5B and 5C are diagrams illustrating rotation states of the upper side member 303c and the lower side member 303d. FIG. 5A is a side view of the upper side member 303c and the lower side member 303d viewed from the lefthand side in FIGS. 4A, 4B and 4C toward the side faces of these members. In a state shown n FIG. 5A, neither one of the members is rotated so that a coin 501 can be supported. FIG. 5B illustrates a movement of the upper side member 303c in case where the return button 107 is operated (Refer to FIGS. 1, 3A, and 3B for the return button 107). In the state shown in FIG. 5A, when a force is applied to the projection 405 in a direction shown in a downward arrow in accordance with the operation performed to the return button 107, the upper side member 303c is rotated in a clockwise direction shown in a curved arrow with respect to the rotation axis 406 as a center of rotation, whereby the state of the upper side member 303c shown in FIG. 5A shifts to a state shown in FIG. 5B where the upper side member 303c is opened (inclined) on an upper side thereof. In the state shown in FIG. 5B, since the projection portion 402a for regulating rolling of coins 501 is withdrawn from the path of the coin 501, the coin 501 rolls down along the inclination of the lower side member 303d. In this embodiment, a tip portion of the projection portion 402a (the left side of the projection portion 402) is tapered (cut out) on a lower side thereof so that the rotation angle of the upper side member 303c can be made small.

FIG. 5C is a diagram illustrating a movement of the lower side member 303d in case where the lock of the drive unit 307 is released and the handle 103 (Refer to FIG. 1) is rotated. In the state shown in FIG. 5A, when a force is applied to the projection 408 in a direction shown in a downward arrow, in accordance with an operation to the handle 103, the lower side member 303d is rotated in a counter clockwise direction shown in a curved arrow with respect to the rotation axis 407 as a center of rotation, whereby the state of the lower side member 303d shown in FIG. 5A shifts to the state shown in FIG. 5C where the lower side member 303d is opened (inclined) on a lower side thereof. In the state shown in FIG. 5C, since the bottom face portion 409 of the lower side member 303d, which supports the coin 501, is withdrawn from the bottom side of the coin 501, the coin 501 falls down in the downward direction. Unlike the projection 402a, the tip of the bottom face portion 409 is not tapered (cut out).

In FIGS. 5A, 5B and 5C, only the structure of the first holding unit 303 is shown. In the same manner, the second holding unit 304 may be configured. Since a force is applied to the first holding unit 303 and the second holding unit 304 at the same time, the upper side members 303c and 304c are moved at the same time in a direction in which the upper side members 303c and 304c are separated from each other. In addition, both the lower side members 303d and 304d are moved at the same time in a direction in which lower sides thereof are separated from each other.

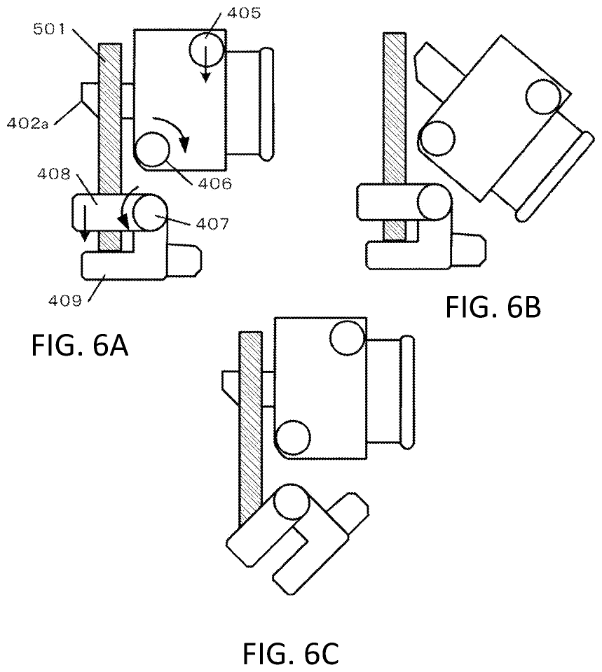

The configuration of first holding unit 303 and that of the second holding unit 304 are explained from another point of view, referring to FIGS. 6A, 6B and 6C. FIG. 6A is a top view of an example of the structure of the first holding unit 303 and the second holding unit 304 viewed from an upper side thereof. FIG. 6A shows the positional relation between the first holding unit 303 and the second holding unit 304 in a state where the first holding unit 303 and the second holding unit 304 are attached to the holding mechanism 300. As described above, a rotation axis is attached to each of the first holding unit 303 and the second holding unit 304, and in FIG. 6A, the position of the righthand side end of the first holding unit 303 excluding the rotation axis is shown by a dotted line and the position of the righthand side end of the second holding unit 304 excluding the rotation axis is shown by a dash-dot line. As can be seen in FIG. 6A, one end of the second holding unit 304 protrudes further than the first holding unit 303 in a coin discharge direction (toward a front side of the article supply apparatus 100). This is because the upper side member 303c of the first holding unit 303 and the upper side member 304c of the second holding unit are arranged so as to be shifted from each other.

FIG. 6B is a top view of an example of the structure of the first holding unit 303 and the second holding unit 304 viewed from a lower side thereof. FIG. 6B shows the positional relation between the first holding unit 303 and the second holding unit 304 in a state where the first holding unit 303 and the second holding unit 304 are attached to the holding mechanism 300. In FIG. 6B, a portion shown by a reference numeral 601 is a cut out portion formed at one end of the lower side member 304d of the second holding unit 304, specifically at an end of the second holding unit 304 in the coin discharge direction (toward a front side of the article supply apparatus 100). This cut-out portion 601 is formed in only the second holding unit 304 and is not formed in the first holding unit 303. No cut-out port is formed in the other end on an opposite side to the end where the cut-out portion 601 is formed.

FIG. 6C shows a left bottom perspective view of the configuration of the first holding unit 303 and the second holding unit 304 as an example. Also, FIG. 6C shows the positional relation between the first holding unit 303 and the second holding unit 304 in a state where the first holding unit 303 and the second holding unit 304 are attached to the holding mechanism 300. In FIG. 6C, dot lines show the center positions of the respective depressed portions 303b formed in the first holding unit 303 and dash-dot lines show the center positions of the respective depressed portions 304b formed in the second holding unit 304. As can be seen in FIG. 6C, the depressed portions 303b and the depressed portions 304b are arranged so as to be shifted from each other. In this embodiment, the depressed portions 304b of the second holding member 304 are shifted from the depressed portions 303b of the first holding unit 303 in the coin discharge direction (toward the front side of the article supply apparatus 100). Thus, in this embodiment, the coin holding position of the first holding unit 303 are different from that of the second holding unit 304.

As described above, the first holding unit 303 is arranged so as to be shifted from the second holding unit 304 in the coin discharge direction (toward the front face side of the article supply apparatus 100), and the cut-out part is formed in the end portion side of the lower side member 303d. Further, regarding the depressed portions 303b and 304b which respectively position the first adjustment members 303a and 303b, the depressed portions 304b is also arranged so as to be shifted from the depressed portions 303b in the coin discharge direction (toward the front side of the article supply apparatus 100). By this configuration, when coins are discharged from the first holding unit 303 and the second holding unit 304, the coins are discharged from the first holding unit 303 and the second holding unit 304 alternately so that it is possible to prevent coins from jumping out from the article supply apparatus 100 due to coin collisions.

In another embodiment, the positional relation between the first holding unit 303 and the second holding unit 304 may be counterchanged so that an end portion of the first holding unit 303 is stuck out from that of the second holding unit 304 in the coin discharge direction and a cut-out portion may be formed in the end portion of the lower side member 304d. The positions of the depressed portions 303b and 304b may be counterchanged so that the depressed portion 303b is arranged so as to be shifted from the depressed portion 304b in the coin discharge direction (toward the front face side of the article supply apparatus 100).

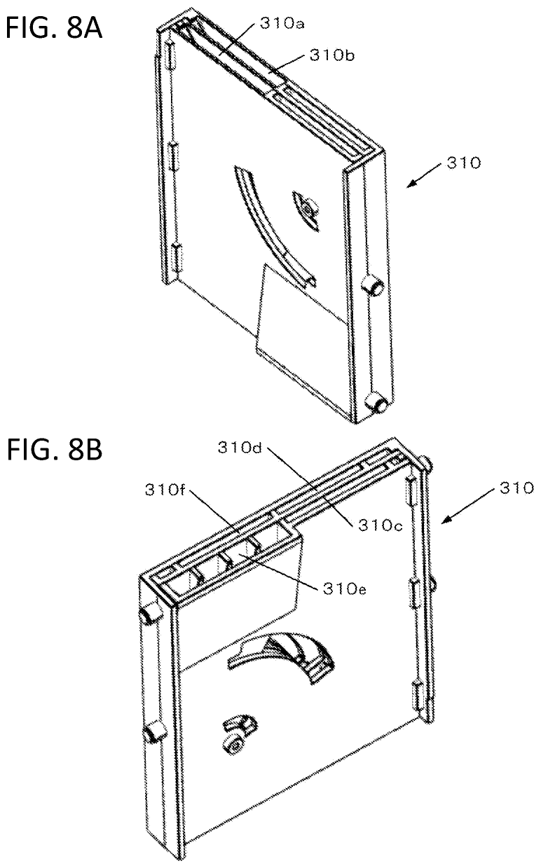

FIG. 7 shows the structure of the holding mechanism 300 as an example in a state where the discrimination unit 310 is removed therefrom. The holding mechanism 300 has a first opening 701 and a second opening 702, wherein the first opening 701 is configured to communicate with the first feeding port 104A and the second opening 702 is configured to communicate with the second feeding port 104B. The first opening 701 and the second opening 702 respectively correspond to the first feeding port 104A and the second feeding port 104B in size. But the size of the first opening 701 is different from that of the second opening 702. In the embodiment shown in FIG. 7, the width of the second opening 702 is greater than that of the first opening 701. Coins fed in these openings respectively pass through a first path part 302A and a second path part 302B, which are provided in the first inclined portion 302, and are supplied to the discrimination unit 310. The first path part 302A and the second path part 302B are arranged so as to face each other. Referring to FIG. 7, the structure other than that of the discrimination unit 310 will be explained below. The discrimination unit 310 will be explained referring to FIGS. 8A and 8B.

The mounting unit 311, to which the discrimination unit 310 is attachable, is formed in the main body portion 301. The mounting unit 311 has a depressed portion (space) corresponding to the outer shape of the discrimination unit 310. An opening 305a connected to the discharge passage 305 is formed below the mounting unit 311. When the discrimination unit 310 does not determines that a coin fed in the first feeding port 104A is appropriate or authentic, the coin is discharged through an opening 305a to the discharge path 305, and then passes through the discharge path 305 so as to be discharged from the opening 305b to the return port 106.

Further, an opening 703 is provided below the mounting unit 311 wherein a coin fed in the second feeding port 104B is discharged from the opening 703 when the discrimination unit 310 does not determine that the coin is appropriate or authentic. The discriminated coin is discharged through the opening 703 to a discharge path (not shown), passes through the discharge path, and then discharged from the opening 704 to the return port 106. In addition to the openings 305b and 704, openings 705 and 706 are communicated with the return port 106. The coins held in the first holding unit 303 are discharged from the opening 705 when a holding state where the coins are held in the first holding unit 303 is released thereby transiting into a non-holding state. The coins held in the second holding unit 304 are discharged from the opening 706, when a holding state where the coins are held in the second holding unit 304 is released thereby changing into a non-holding state.

Further, openings 707 and 708 are provided below the mounting unit 311 wherein coins fed in the first feeding port 104A and the second feeding port 104B are discharged respectfully from the openings 707 and 708 when the discrimination unit 310 determines that the coins are appropriate. The coins discharged from the opening 707 are held in the first holding unit 303 and the coins discharged from the opening 708 are held in the second holding unit 304.

The discrimination unit 310 will be explained referring to FIGS. 8A and 8B. FIGS. 8A and 8B are diagrams showing an example of an exterior structure of a discrimination unit 310 according to an embodiment. Specifically, FIG. 8A shows a front left top perspective view of the discrimination unit 310, and FIG. 8B shows a front left bottom perspective view thereof. As shown in FIG. 8A, the discrimination unit 310 has a first opening portion 310a and a second opening portion 310b. Coins, which are fed in the first feeding port 104A and which are supplied in the discrimination unit 310 through the first path part 302A, are collected in the first opening portion 310a, and coins, which are fed in the second feeding port 104B and which are supplied in the discrimination unit 310 through the second path part 302B, are collected in the second opening portion 310b.

The discrimination unit 310 detects feeding of a coin when the coin is collected, and notifies the control unit 201 of it. When the control unit 201 receives the notification, the control unit 201 updates a count value of the coins. The discrimination unit 310 performs an authentication judgment with respect to the fed coins, and if the coin is proper or authentic, the coin is discharged into the opening 707 (or the opening 708) shown in FIG. 7, which is connected to the first holding unit 303 (or the second holding unit 304) through the path connected to the first holding unit 303 (or the second holding unit 304) from a third opening 310c (or a fourth opening 310d) which is formed on the bottom face of the discrimination unit 310.

As described above, in the holding mechanism 300, the first path part 302A and the second path part 302B are formed, wherein coins fed in the first feeding port 104A are led to the first holding unit 303 through the discrimination unit 310 from the first path part 302A so that the first path is communicated with the first holding unit 303 and coins fed in the second feeding port 104B are led to the second holding unit 304 through the discrimination unit 310 from the second path part 302B so that the second path is communicated with the second holding unit 304.

When the discrimination unit 310 judges that a coin fed in the first feeding port 104A is not authentic (proper), the coin is discharged into the opening 305a from a fifth opening portion 310e. Similarly, a coin fed in the first feeding port 104B is discharged into the opening 703 from a sixth opening portion 310f. When it is determined as a result that the coin is not authentic, the discrimination unit 310 notifies the control unit 201 of it. The control unit 210 does not update the count value of the coins when the control unit 201 receives the notification that it is not authentic (proper). Authentic (proper) coins cannot pass through the fifth opening portion 310e and the sixth opening 310f, and only coins other than the authentic (proper) coins can pass therethrough. However, when an electronic payment by the electronic payment unit has been completed by the electronic payment unit 206, the control unit 201 controls the discrimination unit 310 so that the fed authentic (proper) coins may pass through the fifth opening portion 310e and the sixth opening 310f even though the fed coins are authentic (proper).

In the holding mechanism 300, a third path part and a fourth path part are formed. In the third path, coins fed in the first feeding port 104A are led to the return port 106 via the opening 305a after passing through the discrimination unit 310 from the first path part 302A so that the first feeding port 104A is communicated with the return port 106. In the fourth path coins fed in the second feeding port 104B are led to the return port 106 via the opening 703 after passing through the discrimination unit 310 from the first path part 302B so that the second feeding port 104B is communicated with the return port 106.

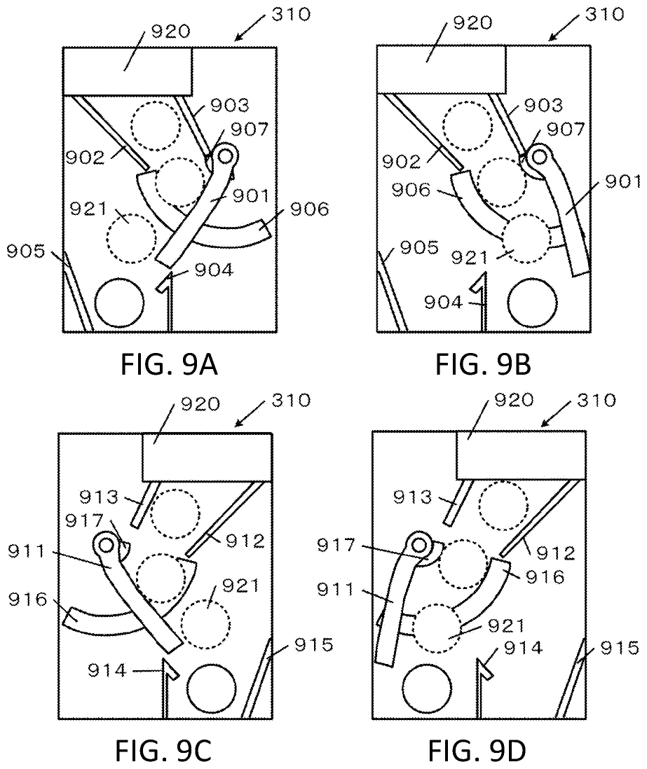

An interior structure of the discrimination unit 310 will be explained referring to FIGS. 9A, 9B, 9C and 9D. FIGS. 9A and 9B show an example of the structure of part of the discrimination unit 310 where a coin fed in the first feeding port 104A is discriminated. FIGS. 9C and 9D show an example of the structure of part of the discrimination unit 310 where a coin fed in the second feeding port 104B is discriminated.

The discrimination unit 310 has a discrimination mechanism 920 for discriminating whether or not the fed coin is authentic or proper. The discrimination mechanism 920 may be configured mechanically or electrically. Or the discrimination mechanism 920 may be configured by a combination of a mechanical structure and an electric structure. An explanation of a concrete configuration of the discrimination mechanism 920 is left out because it is not the subject matter of the present invention. A publicly known configuration for determining whether or not a coin is authentic can be used as the discrimination mechanism 920.

The discrimination unit 310 has an oscillating member 901 for switching between the route through which coins are discharged to the first holding unit 303 (the first path part) and the route through which coins are discharged to the return port 106 (the third path part), in accordance with the result of the determination by the discrimination mechanism 920. In accordance with the determination result by the discrimination unit 920, the oscillating member 901 is positioned so that coins are directed to the first holding unit 303 for discharge as shown in FIG. 9A, or the coins are directed to the return port 106 for discharge as shown in FIG. 9B. The oscillating member 901 is connected to a control mechanism which is not shown (controlled by the control unit 201 or discrimination unit 920) through the openings 906 and 907 and is oscillated along the shape of the openings 906 and 907.

In addition, ribs 902, 903, 904 and 905 are formed in discrimination unit 310 in order to set a route of coins, whereby the route of the coins is determined depending on the position of the oscillating member 901 and ribs 903, 094 and 905. In FIGS. 9A through 9D, circles 921 shown in a dot line or solid line indicate a track of a coin. In FIG. 9A, a coin, which is determined as an authentic (proper) coin and discharged from the discrimination mechanism 920, rolls down therefrom and contacts with the oscillating member 901, whereby the moving direction of the coin is changed, and then the coin proceeds between the ribs 904 and 905. In this route, the coin is discharged to the opening 707 shown in FIG. 7 from the third opening 310c shown in FIG. 8B, and is held in the first holding unit 303. Next, in FIG. 9B, a coin, which is determined as improper or counterfeit and discharged from the discrimination mechanism 920, rolls down and proceeds on the righthand side of the rib 904 without changing the direction thereof by the oscillating member 901. In this route, the coin is discharged from the fifth opening portion 310e shown in FIG. 8B to the opening 305a and then discharged from the return port 106.

The discrimination unit 310 has further an oscillating member 911 for switching between the route through which coins are discharged to the second holding unit 304 (the second path part) and the route through which coins are discharged to the return port 106 (the fourth path part), in accordance with a result of the determination by the discrimination mechanism 920. In this embodiment, the oscillating members 901 and 911 are independently controlled. This is because coins are fed at the same time in the first feeding port 104A and the second feeding port 104B.

In accordance with the determination result by the discrimination unit 920, the oscillating member 911 is positioned so that coins are directed to the second holding unit 304 for discharge as shown in FIG. 9C, or the coins are directed to the return port 106 for discharge as shown in FIG. 9D. The oscillating member 911 is connected to the control mechanism which is not shown (controlled by the control unit 201 or discrimination unit 920) through the openings 916 and 917 and is oscillated along the shape of the openings 916 and 917.

In addition, the oscillation range of the oscillating member 911 is wider than that of the oscillating member 901. This is because the length of the rib 903 is longer than that of the rib 913 and extends to the vicinity of the oscillating unit 901 so that the oscillation range of the oscillating member 901 is limited by the rib 903. The reason why the rib 913 is short is that when a plurality of coins pass therethrough at the same time, it prevents interference due to the rib 913 with the movements of coins so that the coins may not be clogged therein. In another embodiment, the length of the rib 903 may be set so as to be shorter than that of the rib 913 so that the oscillation range of the oscillating member 901 is wider than or equal to that of the oscillating member 911.

In addition, ribs 912, 913, 914 and 915 are also formed in the discrimination unit 310 whereby a route of the coins is determined depending on the position of the oscillating member 911 and the ribs 912 through 915. In FIG. 9C, a coin, which is determined as an authentic or proper coin and discharged from the discrimination mechanism 920, rolls down therefrom and contacts with the oscillating member 911, whereby the moving direction of the coin is changed, and then the coin proceeds between the ribs 914 and 915. In this route, the coin is discharged to the opening 708 shown in FIG. 7 from the fourth opening portion 310d shown in FIG. 8B, and is held in the first holding unit 304. Next, in FIG. 9D, a coin, which is determined as an improper or counterfeit coin and discharged from the discrimination mechanism 920, rolls down and proceeds on the lefthand side of the rib 914 without changing the direction thereof by the oscillating member 911. In this route, the coin is discharged from the sixth opening portion 310f shown in FIG. 8B to the opening 703 and then proceeds toward the return port 106.

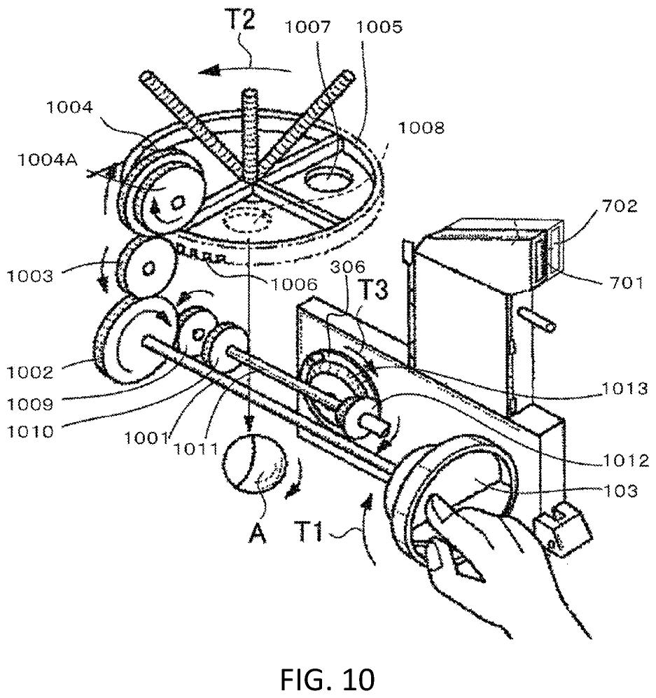

Next, a transmission mechanism for transmitting a power in accordance with an operation performed to the handle 103 will be explained referring to FIG. 10. FIG. 10 is a schematic perspective view of the transmission mechanism for transmitting a power. In FIG. 10, an end of a main shaft body 1001 of the handle 103, which forms part of a gear interlocking mechanism, is attached to a rotation center shaft of the handle 103. A spur gear 1002 is fixed to the other end of this main shaft body 1001. A pinion 1003, which is engaged with the spur gear 1002, is rotatably journalled above the spur gear 1002. Further, a spur gear 1004, which is engaged with the pinion 1003, is rotatably journalled above the pinion 1003. The spur gear 1004 is integrally formed with a gear portion 1004A, whose center axis is the same as that of the spur gear 1004.

A rotating table 1005 is rotatably provided above an intermediate wall which forms a bottom wall of the accommodation unit 101. Gear teeth 1006 are formed on a bottom face of the rotating table 1005 and the gear portion 1004A is engaged with the gear teeth 1006. Therefore, when the handle 103 is rotated in one direction shown in an arrow T1 by hand, a rotation force is transmitted to the spur gear 1002 via the main shaft body 1001 so that the rotation force is transmitted to the rotation table 1005 via the pinion 1003 and the spur gear 1004 engaged therewith in a direction shown in an arrow T2. When the operation performed to the handle 103 is continued whereby the rotation table 1005 is rotated by a predetermined angle and when one of cut-outs 1007 formed on the rotation table 1005 is matched with a take-out hole 1008 formed on the intermediate wall of the accommodation unit 101, one of accommodated objects A which are accommodated in the accommodation unit 101, passes through the cut-out of the rotation table 1005 and is sent to the take-out port 105 whereby the object A is taken out from the take-out port 105. In addition, a spur gear 1009, which is engaged with the spur gear 1002, is rotatably journalled in a diagonally downward direction of the spur gear 1002. A pinion 1010, which is connected to the spur gear 1009, is connected to one end of an intermediate shaft 1011, and the intermediate shaft 1011 is rotatable journalled near the spur gear 1009. In addition, a bevel gear 1012 is attached to near the other end of the intermediate shaft 1011

When a user rotates the handle 103, the main shaft body 1001 is rotated whereby the spur gear 1002 is rotated. On one hand, this rotates the rotation table 1005 via the pinion 1003, the spur gear 1004 and the gear portion 1004A. On the other hand, the intermediate shaft 1011 is rotated via the spur gear 1009 and the pinion 1010 by the rotation of the spur gear 1002 thereby rotating the bevel gear 1012. In the above-described configuration, if the rotation of the bevel gear 1012 is restricted, the rotation of the handle 103 and that of the rotation table 1005 is restricted.

A bevel gear 1013 is engaged with the bevel gear 1012. Therefore, the bevel gear 1013 rotates when the bevel gear 1012 rotates with the rotation of the handle 103. However, since the bevel gear 1013 is integrally formed with a rotation member 306, when the rotation of the rotation member 306 is locked, the bevel gear 1013 cannot be rotated, so that the rotation of the handle 103 is restricted. Thus, since rotation of the bevel gears 1012 and 1013 is restricted in a state where the rotation member 306 is locked, the handle 103 cannot be rotated. Since the handle 103 cannot be rotated, the rotation table 1005 is not rotated so that an accommodated object A cannot be taken out.

In addition, in FIG. 10, the main shaft body 1001, which is directly engaged with the handle 103 and the intermediate shaft 1011 to which the bevel gear 1012 engaged with the rotation member 306 is attached are exemplified as separated members. However, the bevel gear 1012 may be attached to the main shaft body 1001.

Although only some exemplary embodiments have been described in detail above, those skilled in the art will readily appreciate that many modifications are possible in the exemplary embodiments without materially departing from the novel teachings and advantages. Accordingly, all such modifications are intended to be included within the scope.

1. A holding device capable of holding coins comprising:
a first opening in which a first group of the coins are fed;
a second opening in which a second group of the coins are fed;
a first path part through which the first group of the coins fed in the first opening pass;
a path part through which the second group of the coins fed in the second opening pass;
a first holding unit capable of holding the first group of the coins which pass through the first passage; and
a second holding unit capable of holding the second group of the coins which pass through the second passage,
wherein the first pass part and the second path part face each other, and the first holding unit and the second holding unit face each other.

2. The holding device according to claim 1, wherein the first holding unit has a first setting portion which adjustably sets the number of coins capable of being held in the first holding unit, and the second holding unit has a second setting portion which adjustably sets the number of coins capable of being held in the second holding unit.

3. The holding device according to claim 2, wherein the first setting portion and the second setting portion face each other in a state where the first setting portion and the second setting portion are shifted from each other.

4. The holding device according to claim 2, wherein one end of the second setting portion is arranged so as to protrude further than one end of the first setting portion toward a front face side of the holding device.

5. The holding device according to claim 2, further including a first operation portion by which the first and second groups of coins held in the first holding unit and the second holding unit are returned, wherein an upper portion of the first setting portion and that of the second setting portion are moved so as to be separated from each other according to an operation performed to the first operation portion.

6. The holding device according to claim 1,
wherein the first setting portion includes a first adjustment member capable of adjusting a position thereof along the first setting portion,
the first adjustment member comprises a first projection portion extending in a first direction and a second projection portion which is integrally formed with the first projection and extends in a second direction opposite to the first direction,
the first projection portion capable of changing a position thereof in the first setting portion, functions as a second operation portion
the second projection portion is capable of restricting an advance of the first group of the coins held in the first holding unit,
the second setting portion includes a second adjustment member capable of adjusting a position thereof along the second setting portion,
the second adjustment member includes a third projection portion which projects in the second direction, and a fourth projection portion, which is integrally formed with the third projection portion and projects in the first direction, and
the third projection portion capable of changing a position of the second setting portion, functions as a third operation portion,
the fourth projection portion is capable of restricting an advance of the second group of the coins held in the second holding unit.

7. The holding device according to claim 1, wherein the first holding unit and the second holding unit are arranged in the holding device so that a holding position of the first group of the coins held in the first holding unit is different from that of the second group of the coins held in the second holding unit.

8. The holding device according to claim 1, wherein the first holding unit and the second holding unit are configured so that a maximum number of coins held in the first holding unit is different from that held in the second holding unit.

9. The holding device according to claim 8, wherein the first holding unit is configured so that when the maximum number of the coins for the first holding unit are held in the first holding unit, a first coin fed in the first holding unit is held at a position with a predetermined distance from one end of the first holding unit,
the second holding unit is configured so that when the maximum number of the coins for the second holding unit is held in the second holding unit, a first coin fed in the second opening is held near one end of the second holding unit.

10. The holding device according to claim 8, the maximum number of coins held in the first holding unit is four, and the maximum number of coins held in the second holding unit is five.

11. The holding device according to claim 1, further including a discrimination unit configured to discriminate coins fed in the first and second openings, wherein the discrimination unit is detachably arranged below the first path part and the second path part and above the first holding unit and the second holding unit, and the discrimination unit includes a first oscillating member with which the first group of coins fed in the first opening contact, and a second oscillating member with which the second group of coins fed in the second opening contact.

12. The holding device according to claim 11, wherein an oscillation range of the first oscillating member is different from that of the second oscillating member.

13. The holding device according to claim 12, wherein the first oscillating member and the second oscillating member are configured to change a moving direction of the first group of coins fed in the first opening and those of the second group of coins fed in the second opening.

14. The holding device according to claim 1, wherein the discrimination unit is configured so that when the discrimination unit is attached to the holding device, the first group of the coins fed in the first opening are advanced to the first holding unit, and the second group of the coins fed in the second opening are advanced to the second holding unit.

15. The holding device according to claim 1, wherein a cut-out portion is formed in a lower end portion of one end of either the first holding unit or the second holding unit.

16. The holding device according to claim 1, wherein a size of first opening and that of the second opening are different from each other.

17. The holding device according to claim 1, wherein the first holding unit and the second holding units are configured so that a lower side of the first holding unit and a lower side of the second holding unit are moved so as to be separated from each other when each of the first holding unit and the second holding unit holds a predetermined number of coins.

18. An article supply apparatus capable of supplying articles, comprising:
a holding device according to claim 1, wherein the holding device is capable of holding coins fed in the article supply apparatus;
an accommodation unit which accommodates the articles; and
a fourth operation portion which is operated to supply one of the articles accommodated in the accommodation unit,
wherein according to an operation performed to the fourth operation portion, a lower side of the first holding unit and a lower side of the second holding unit are moved so as to be separated from each other.

19. The article supply apparatus according to claim 18, wherein the fourth operation portion is arranged so as to be operated form an outside of the article supply apparatus, and the second operation portion and the third operation portion are configured so as not be operated from the outside of the article supply apparatus.

20. The article supply apparatus according to claim 18, further including a first feeding port and a second feeding port in each of which coins can be fed, wherein the first feeding port is connected to the first opening of the holding device and the second feeding port is connected to the second opening of the holding device.
